(19) United States
(12) Patent Application Publication
(10) Pub. No.: US 2015/0170262 A1
(43) Pub. Date: Jun. 18, 2015

(54) SYSTEM AND METHOD FOR PROVIDING AUCTION RESERVATION IN A COMMUNICATIONS NETWORK

(71) Applicant: Kyle Anthony Collier, Waterloo (CA)

(72) Inventor: Kyle Anthony Collier, Waterloo (CA)

(21) Appl. No.: 14/107,056

(22) Filed: Dec. 16, 2013

(51) Int. Cl. G06Q 30/08

(52) U.S. Cl. CPC G06Q 30/08

(57) ABSTRACT

The present invention relates to an improved online auction reservation system and method which allows a user to bid for, obtain and reserve a booth/table/location at a selected venue in that network. A computing device associated with the network interconnects a plurality of venues through the network, allowing user to attempt to obtain reservations on selected date at a selected venue within the network. The users can then select a specified reservation location within that selected venue, and an on-line auction process ensues from different users within the network to secure a specified reservation location and time within the selected venue. The auction bids are assessed from amongst the bidders to establish a highest bid for that reservation within the selected venue, and the reservation is ultimately awarded to the highest bidder.

### FIELD OF THE INVENTION

The present invention relates generally to an online auction reservation system and method that allows users access to a plurality of interconnected venues in a network, and more particularly to an online auction reservation system and method which allows a user to bid for, obtain and reserve a booth/table/location at a selected venue in that network, using items that are commonly sold at the venue as the means of currency throughout the bidding process.

### DESCRIPTION OF THE PRIOR ART

It is well known that on-line auctions and auction sales have rapidly become a proven selling method for products and services over the Internet, with sites such as E-Bay being well known and utilized by millions. Other types of on-line auctions allow users to potentially refine their on-line search to particular items in a geographic location, with a view to finding the best prices for that product without ever having to directly visit a retailer. U.S. Pat. No. 7,133,835 is an example of such a configuration.

It is also accepted, common, every-day practice to make reservations in advance to secure a location at a desired establishment, restaurant or the like. Gradually, systems enabling on-line reservation capability have emerged. WO2008109338 A1 is an example of a system providing for a system reservation, but is one which is contained to seating patrons solely at a particular localized venue, rather than over an interconnected network containing many venues and establishments.

Accordingly, there is a need for an improved online auction reservation system and method that allows users access to a plurality of interconnected venues in a network, and which allows a user to bid for, obtain and reserve a booth/table/location at a selected venue in that network. There is a need for an improved online auction reservation system and method that allows users to bid for, obtain and reserve a booth/table/location at a selected venue in that network by bidding to purchase goods particular to that venue as the auction currency. To this end, the present invention effectively addresses this need.

### SUMMARY OF THE INVENTION

A general object and advantage of the present invention is to provide an improved online auction reservation system and method that allows users access to a plurality of interconnected venues in a network.

A further object and advantage of the present invention is to provide an improved online auction reservation system and method which allows a venue moderator to set the rules (date of auction start, end date, minimum starting price, reserve price, buy it now prices) of the auction that allows a user to bid for, obtain and reserve a booth/table/location at a selected venue on a specific date in that network.

A still further object and advantage of the present invention is to provide an improved online auction reservation system and method that allows users to bid for, obtain and reserve a booth/table/location at a selected venue in that network by bidding to purchase goods particular to that venue as the auction currency.

According to one aspect of the present invention, there is provided an auction reservation system for use over a network, the system comprising providing a computing device associated with the network; interconnecting, via the computing device, a plurality of venues through the network, each of the venues having means for displaying information regarding the plurality of venues to a plurality of prospective customers; providing means for receiving reservation information for each of a selected date and a selected venue within the network from the prospective establishment customers; providing means for the prospective establishment customers to select a specified reservation location within the selected venue in the network; receiving auction bid information from the prospective establishment customers to secure the specified reservation location within the selected venue in the network; assessing the auction bid information received from any of the prospective establishment customers to establish a highest bid for the specified reservation location within the selected venue in the network; awarding the specified reservation location to the highest bid received from among the prospective establishment customers; and displaying the highest bid to all bidders for that specified reservation location within the selected venue from among the prospective establishment customers.

According to another aspect of the present invention, there is provided an auction reservation system for use over a network, the system comprising providing a computing device associated with the network; interconnecting, via the computing device, a plurality of venues through the network, each of the venues having means for displaying information regarding the plurality of venues to a plurality of prospective customers; providing means for receiving reservation information for each of a selected date and a selected venue within the network from the prospective establishment customers; providing means for the prospective establishment customers to select a specified reservation location within the selected venue in the network; receiving auction bid information from the prospective establishment customers to secure the specified reservation location within the selected venue in the network; assessing the auction bid information received from any of the prospective establishment customers to establish a highest bid for the specified reservation location within the selected venue in the network; awarding the specified reservation location to the highest bid received from among the prospective establishment customers; communicating to the bidders for that specified reservation location within the selected venue informing the bidders of an identity of the highest bid; and displaying the highest bid to all bidders for that specified reservation location within the selected venue from among the prospective establishment customers.

According to another aspect of the present invention, there is provided an auction reservation system for facilitating an on-line auction bidding process over a communications network, the system comprising at least one computing device associated with the communications network; interconnecting, via the computing device, a plurality of venues through the network, each of the venues having means for displaying information regarding the plurality of venues to a plurality of prospective customers; a central site for coupling to the communications network accessible by the plurality of prospective customers; a server coupled to said central site and comprising a reservation availability database for storing reservation parameters relating to the plurality of venues in the network, a bidder database for storing information related to each bidders from among the plurality of prospective customers, and a processor programmed to provide the prospective customers with auction bid information comprising items sold at the plurality of venues in the network as a form of auction currency through which a bid can be placed by any of the plurality of prospective customers; receive reservation information for each of a selected date and a selected venue within the network from the bidders; receive from the bidders a selection for a specified reservation location within a selected venue in the network; receiving the bid from the bidders to secure the specified reservation location within the selected venue in the network; assess the bid received from the bidders to establish a highest bid for the specified reservation location within the selected venue in the network; awarding the specified reservation location to a highest bid received from among the bidders; and utilizing the sever to display on the central site and the network the highest bid for that specified reservation location within the selected venue from among the bidders; and generating a printable receipt for the bidder having the highest bid received from among the bidders at a conclusion of the on-line auction bidding process.

In essence, the online auction reservation system and method of the present invention is a venue-oriented network, which is fundamentally based on the loose coupling of venues within that network that allows prospective establishment customers to place reservations online for a particular table/booth/location at a selected venue/establishment on a specific date. This reservation process is done online from a device. During this reservation process the prospective establishment customers engage in a competitive auction style bidding process on individual table/booth/locations for the selected venue/establishment. Each bid in the process is placed by selecting the table/booth/location at the selected venue/establishment to bid on and creating a purchase list using provided menu or other items from the selected venue/establishment.

In this manner, the present invention provides an improved online auction reservation system and method which allows a user to bid for, obtain and reserve a booth/table/location at a selected one of a plurality of venues in an interconnected network.

### BRIEF DESCRIPTION OF THE DRAWINGS

A preferred embodiment of the present invention is described below with reference to the accompanying drawings, in which:

FIG. 1 illustrates a flowchart, in accordance with an embodiment of the present invention;

FIG. 2 is a diagram of one possible Internet embodiment of a hardware configuration for which the present invention could be applied;

FIG. 3 is an alternative embodiment of a network configuration that could be used to implement the present invention; and

FIG. 4 is a diagram of further components and hardware that could be used to implement the configuration of the present invention set forth in FIG. 3.

### DESCRIPTION OF THE PREFERRED EMBODIMENT

In a preferred embodiment, the present invention essentially provides an improved online auction reservation system and method which allows prospective establishment customers to bid for, obtain and place reservations online for a particular booth/table/location at a selected one of a plurality of venues in an interconnected network on a specific date. During this reservation process the prospective establishment customers engage in a competitive auction style bidding process on individual table/booth/locations using items sold at the establishment as the means of currency.

It will of course be understood that prospective establishment customers is a term that can be used to describe those individuals (or groups) considering or attempting to reserve a table/booth/location at an establishment, and that the term “Table/booth/location” can be construed to refer to a physical location within an establishment, that could include, but is not limited to, a dining table, VIP booth, chairs, couch, end-table, bar space, stools, essentially any area that can be temporarily rented to a prospective establishment customer for a set amount of time. It will also be understood that any facility that doubles as a public gathering place could be considered a venue in the context of the present invention, as would be clear to one skilled in the art, and that an establishment is a term that can be used to describe a location or business that owns and has the right to auction various table/booth/locations, such as a bar, restaurant, night club, but not of course being limited to these.

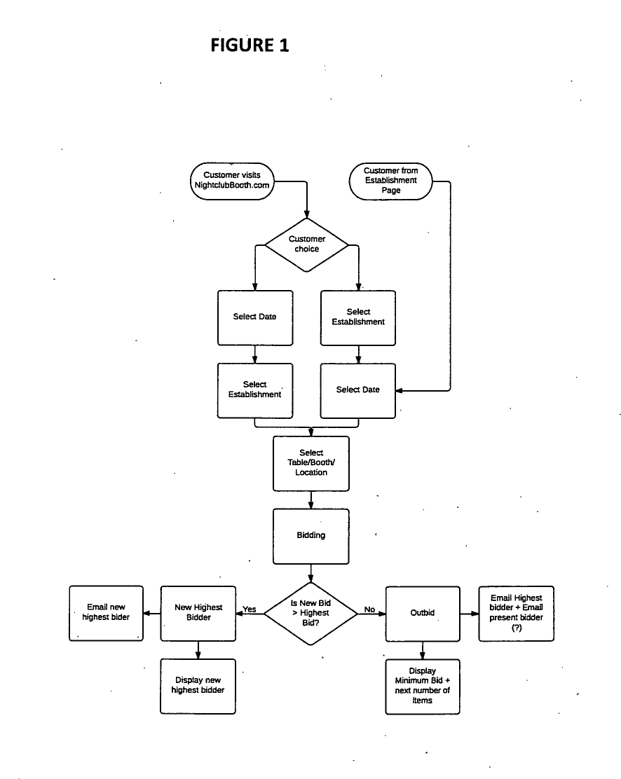

The previously noted reservation process is done online from a device, and it will be understood that the term “device” can be construed to mean, but is not limited to, a computer, mobile device, tablet, smart phone, a wearable electronic device, smart watch, or other electronic device with access to the Internet, or the like, and thus to the interconnected network. FIG. 1 is a flow chart illustrating operation of the online auction reservation system and method consistent with one aspect of the present invention.

The present invention is designed to interconnect a plurality of venues through an interlinked network, as a network based community. This can be done through the venues/restaurants/establishments subscribing to become members of that network based community, but is not absolutely essential. This provides a viral network and collective of venues interconnecting to establish a shared resource and a marketplace amongst its membership for allowing prospective establishment customers to bid for, obtain and place reservations online for a particular booth/table/location at any selected one of a plurality of venues in the interconnected network on a specific date. It will, of course, be understood that as more venues participate in the network the value of the network builds exponentially, with each member thus helping to make the service more attractive to prospective establishment customers. In essence, the more members of the network means a greater number of people that are potentially accessible for prospective establishment customers to bid for, obtain and place reservations online for a particular booth/table/location at any one of the venues in the interconnected network.

In an exemplary embodiment, as can be seen in FIG. 1, prospective establishment customers entering the network and conducting on-line bidding for reservations for a particular booth/table/location at any one of the venues in the network, through a network portal, will conduct the process as follows:
1. Selecting a date for the reservation.
2. Selecting an establishment where the reservation will take place.
3. Selecting a table/booth/location within that establishment.
4. Placing a bid for that table/booth/location within the establishment using items sold at the establishment as the means of currency.

Alternatively, in a variation of this process, the prospective establishment customers can enter the network not through the network portal as noted above, but through a website specific to a particular venue or establishment, and conducting on-line bidding can conduct the process is this alternative manner:
1. Selecting an establishment where the reservation will take place.
2. Selecting a date for the reservation.
3. Selecting a table/booth/location within that establishment.
4. Placing a bid for that table/booth/location within the establishment using items sold at the establishment as the means of currency.
   It will be understood that the expression “means of currency” describes how items are used as a means of currency throughout the competitive auction style bidding process. For example, items that can be commonly bought at a particular establishment are used as the currency instead of a strict monetary currency value, though of course it will be understood that this variation could also be utilized, if desired. As one example, at a nightclub, a bid from a prospective establishment customer for a VIP section at the nightclub may commit to purchasing bottles of alcohol having a set monetary value, of $700. These items represent a strict currency value, where this value is used as the deciding factor on who is winning the current auction for the particular table/booth/location at the specific establishment on the exact date. It should be understood that items sold at a particular establishment are the form of currency throughout the competitive auction style bidding process, instead of a strict currency value, and that these items can be adjusted, modified or changed, changed upon the type of establishment/venue selected.

As another example, a prospective establishment customer “A” bidding for a selected booth at a restaurant on a particular date could bid online, setting their bid in the amount of $500 of good or services offered by the restaurant, which may break down as four entree dinners, and various drink purchases, which of course would bring a minimum of $500 to the selected venue/establishment. If there were no other on-line bids from other prospective establishment customers which are higher than the $500 bid from customer “A”, then customer “A” would win the auction, and obtain that selected booth at that selected restaurant on the selected date. If however, another on-line bid from prospective establishment customer “B” bidding for the same selected booth at that same restaurant on the same date bids a currency valuation higher than the $500 bid set forth by customer “A”, then customer “B” would be the high bidder for that selected booth at that restaurant on that date, usurping customer “A” in the bidding process.

Once the bidding process has begun, it is determined if the newest bid is the highest bid obtained for the table/booth/location in the selected venue/establishment. If so, the new highest bid is displayed to network users, and the highest bidder is notified via email or other form of communication that they are the high bidder. If the newest bid is the highest bid obtained for the table/booth/location in the selected venue/establishment is not the highest, bid, then a prompt is given to the user setting forth the minimum required bid if they wish to bid again, and this bidder is notified via email or other form of communication that they are not the high bidder, being given another opportunity to place a further bid if they wish, or bid to obtain a table/booth/location in another selected venue/establishment on that selected date.

Of course, it will be understood that in such an on-line auction process as that contemplated by the present invention, the network settings can be figured to account for restrictions and management settings for, as an example, but is not limited to, particular table/booth/locations in a particular venue or establishment, setting the available hours for such table/booth/locations that can be bid on by prospective establishment customers. It will also be understood that minimum bid configurations (starting number of items) that will be accepted can also be set, along with such auction settings such as a minimum reserve price or “buy it now” bidding configurations, as would be readily apparent to one skilled in the art.

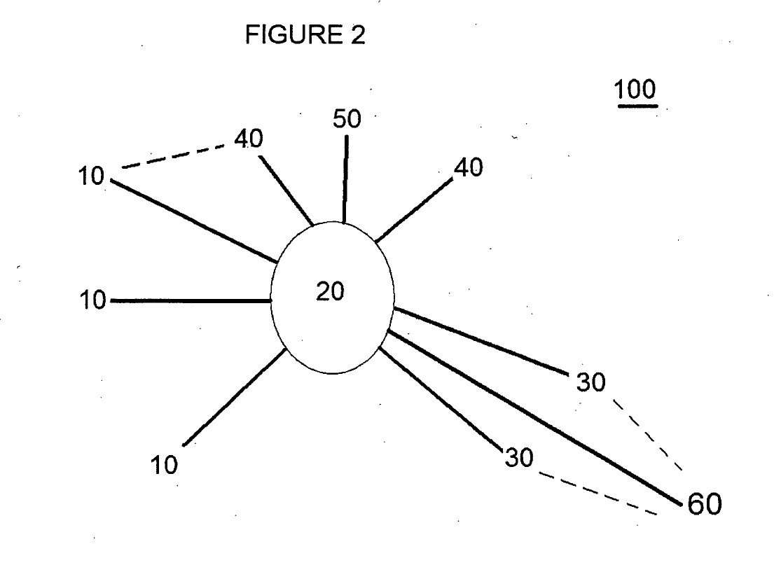

FIG. 2 is a block diagram of an example of the online auction reservation system and method 100 through which the present invention could and may be implemented, though it will be understood that variations to this, in terms of setup and arrangement, are possible. Generally speaking, system and method 100 includes a number of venues, establishments, public gathering places or facilities (“venues”) 10 that are members of a network based community, and which are linked to one another by means of a network 20, it being understood that the venues 10 are connected to one or more servers 50 via the network 20. It will also be understood that the term, “network” as used in the context of the present invention, can refer to a wired network, the Internet, a wireless network, a cellular telephone network, a telecommunications network or a mobile network, for use in conjunction with devices designed to operate on these platforms, such as wireless devices, televisions, monitors, mobile/telephone devices, or any other apparatuses or platform configurations, as would be apparent to one skilled in the art. It is also conceivable that the present invention could be utilized in conjunction with a television environment, and that the network may include a local area network (LAN), a wide area network (WAN), a telephone network, such as the Public Switched Telephone Network (PSTN), an intranet, the Internet, or a combination of networks.

In the context of the present invention, it is also conceivable that the “network” could comprise and link together a plurality of venues in a specific geographic location, such as, for example, Boston, as a local network, and that this local network could be interconnected and linked to one or more other local networks in other geographic locations. Thus, an extensively linked national and globally linked online auction reservation system and network, in an alternative embodiment of the present invention, is possible, the linking of such networks to one other being accomplished through conventional means, as would be apparent to one skilled in the art.

In an exemplary embodiment, at least one network administrator 30 will also be connected to, and thus have access, the network 20. In this manner, the one or more network administrators 30 will be able to provide information and material, if necessary, for prospective establishment customers concerning any of the establishments or venues in the network 20, with a view to directing prospective establishment customers 40 to bid for, obtain and place reservations online for a particular booth/table/location at a selected one of a plurality of venues in the network on a specific date, as will hereinafter be described.

It is also conceivable that prospective establishment customers 40 can have access to the network 20, as shown in FIG. 2, whereby they can access a central website location for entry to the network 20 to bid for table/booth/locations at selected venues 10 on the network 20. Alternatively, prospective establishment customers 40 can have access to the network 20 through entry to a website specific to a particular venue or establishment which is a member of network 20, and conducting on-line bidding over the network 20.

In the example shown in FIG. 2, a central database 60 can be interconnected to the network 20 which can be accessed by the network administrators 30, though it is also conceivable that venues 10 could have access to such a central database 60 as well. Such a central database 60 may have saved thereon, for example, pertinent information regarding each of the venues 10 on the network 20. This information may include, but is not limited to, information from each venue concerning number of table/booth/locations available, location of table/booth/locations in the establishment, location of venue, and the like.

As would be apparent to one skilled in the art, it will be understood that server 50 may additionally include a secondary storage element, such as a database (not shown). It will also be understood that server 50, although depicted as a single computer system in FIG. 2, may be implemented as a network of computer processors, as would be apparent to one skilled in the art.

### In Operation

In utilizing the online auction reservation system and network of the present invention, an advertiser, through either their own contact to network 20 or through contact via a network administrator 30 or venue manager (as noted previously) will access the network 20 through one or more servers 50 connected thereto.

Server 50 may operate as, for example, a network server and can include a search engine. In one implementation, search engine may function as a query-based search engine, to locate relevant information in response to search queries. In response to client requests, search engine may return information to users of the network 20, whether they be prospective establishment customers 40, administrators 30 or venues 10, by returning a list of relevant information to the client, which relate to information regarding venues connected to network 20.

The client requests being provided through search engine of the server 50 would comprise prospective establishment customers 40 entering the centrally located website connected to network 20 and prospective establishment customers 40 selecting a date for a reservation, and selecting a venue 10 where the reservation will take place, it being understood that the order of this in occurring can be varied, with the venue 10 being selected first, then the date required for the reservation. Next, prospective establishment customers 40 select a table/booth/location within that venue 10, and then place a bid for that table/booth/location within the venue 10 using items sold at the venue 10 as the means of currency. Bid information relating to success of the bid is then forwarded back to prospective establishment customers 40 via server 50.

In an alternative embodiment, the prospective establishment customers 40 can enter the network 20 not through the network portal as noted above, but through a website specific to a particular venue 10 (as shown in dotted lines in FIG. 2), then entering the network 20 through this website specific to the particular venue 10 selected. Prospective establishment customers 40 would then select a date for a reservation through the server 50, and select a venue 10 where the reservation will take place, it again being understood that the order of this in occurring can be varied, with the venue 10 being selected first, then the date required for the reservation. Next, prospective establishment customers 40 select a table/booth/location within that venue 10, and then place a bid for that table/booth/location within the venue 10 using items sold at the venue 10 as the means of currency. Bid information relating to success of the bid is then forwarded back to prospective establishment customers 40 via server 50.

It will be understood that entities accessing the network 20 will be utilizing client devices (not shown), which may include a wireless telephone, a personal computer, a personal digital assistant (PDA), a lap top, or another type of computation or communication device, a thread or process running on one of these devices, and/or an object executable by one of these devices. Such client devices will each include a computer-readable medium, such as random access memory, coupled to a processor, for executing program instructions stored in memory, as would be readily apparent to one skilled in the art. Client devices may also include a number of additional external or internal devices, such as, without limitation, a mouse, a CD-ROM, a keyboard, and a display. Of course, through such client devices, entities can communicate over network 20, and with other systems and devices coupled to network 20.

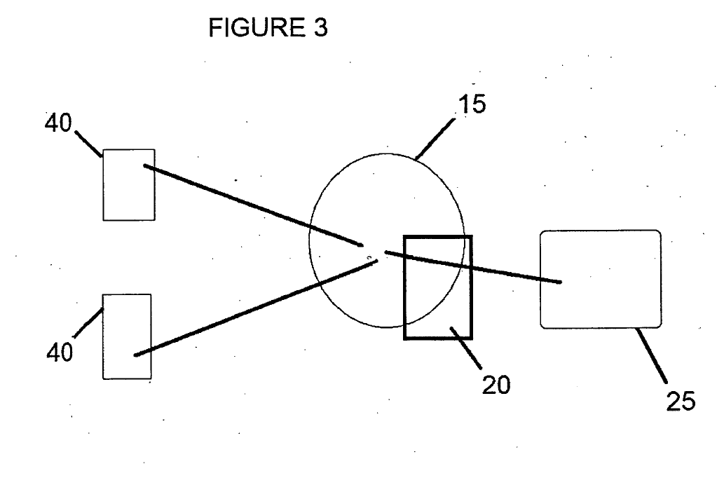

In an alternative embodiment of a network configuration, FIG. 3 illustrates a further example of a system that could be used to implement the present invention. It includes at least computers of prospective establishment customers 40 and a centrally located website 25 (or, perhaps more than one) accessing and connected to network 20, which are linked together by the Internet 15, along with venues 10 which are members of a network based community, and which are linked to one another by means of the network 20. It will it understood that the number of computers of prospective establishment customers 40 which could be engaged in an auction conducted by the present system could be varied, as would be understood by someone skilled in the art. In FIG. 3, for example purposes only, there are two such computers of prospective establishment customers 40 shown.

The centrally located website 25 is a site commonly linked to the network 20 for permitting prospective establishment customers 40 to enter the network therethrough, and place bids bid for table/booth/locations at selected venues on the network 20. Of course, the prospective establishment customers 40 can enter the network 20 not through the network portal as noted above, but through a website specific to a particular venue 10 then entering the network 20 through this website specific to the particular venue 10 selected. The centrally located website 25 of the present invention can comprise hardware of which one component is a server 50 with necessary software components installed therein to conduct on-line auctions as well as to communicate with the computers or on-line devices of prospective establishment customers 40. The network 20 and centrally located website 25 will interact with computers of prospective establishment customers 40 by way of browser 3.

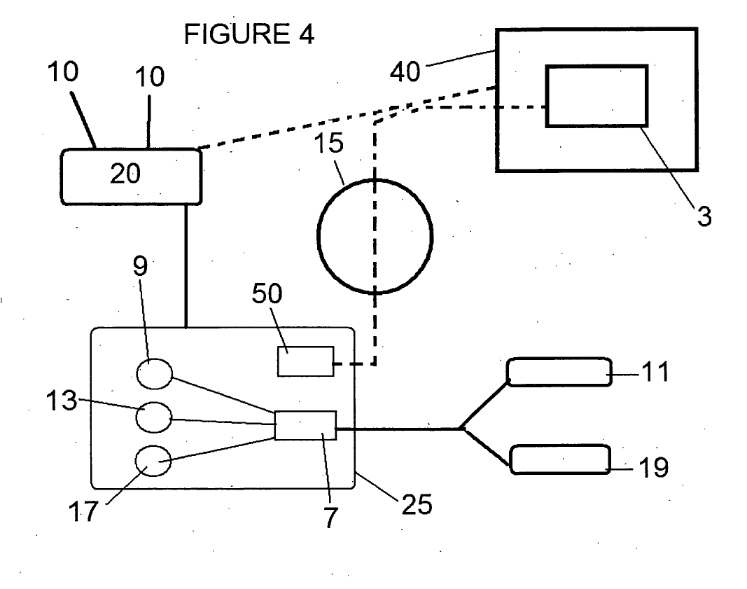

As illustrated in FIG. 4, software components that could be accessed by the server 50 could include a bidding particulars component 11 which could store, administer and monitor the particulars of bids placed by various prospective establishment customers 40 in various on-line auctions contemplated by the present invention.

FIG. 4 illustrates further components and hardware that could be used to implement the configuration of the present invention in more detail. The centrally located website 25 could also include a bid database 9 in which could be stored the particulars of bids placed by various prospective establishment customers 40 on auctions underway. It will be understood that the bid database 9 could also contain additional information which may include, but is not limited to, past bidding history, results of previous auctions, or the like. However, the minimum requirements for the proper operation of the system would be some means of identifying bidders (ie: prospective establishment customers 40) as well as the bid amount and auction information in respect of which the bid is placed.

In operation, a bidder would access the centrally located website 25 through browser 3, to communicate with server 50 of the centrally located website 25. The server 50 allows documents to be requested, retrieved and viewed by prospective establishment customers 40 through browser 3. By way of special hyperlinks or otherwise, the predetermined bid information associated with a particular auction would be displayed to the prospective establishment customers 40 and they could then, via browser 3, select one of those special hyperlinks which would transmit the amount of the bid on the selected venue and other bidder identifying information from the browser 3 to the centrally located website 25 for recordal by the bidding particulars component 11.

In one embodiment or implementation, the centrally located website 25 comprises a reservation availability database 13 containing information about various auction reservation locations/services to be offered for sale by the system of the present invention. Certain documents might be templates which will extract certain information from a reservation availability database 13 for display to a bidder via their browser 3. It will be understood that the reservation availability database 13 could also contain additional information which may include, but is not limited to, information from each venue/establishment concerning number of table/booth/locations available, location of table/booth/locations in the establishment, location of venue, and the like. The computer program/processor 7 of the centrally located website 25 would also use the information from the reservation availability database 13 in the conduct of ongoing on-line auctions.

A bidder from among prospective establishment customers 40 would need to provide identifying information to the centrally located website 25 along with their bid in order that the bid can be properly catalogued and attributed back to the appropriate prospective establishment bidder 40 at the time of selection of a winning bidder once the auction has closed. In one implementation of the auction centrally located website 25, the centrally located website 25 might also include a bidder database 17 which contains details of registered bidders who are able then to transact business with the auctioneer. The bidder database 17 might be managed by computer program 7 in the server 50, or possibly by a network administrator (not shown) which might also assign some type of an identifier or symbol to each registered bidder which the bidder could then use as an abbreviation to identify themselves to the system in placing a bid.

As will be apparent, bidding would cease and the auction would close upon detection of an auction-closing event by an auction software component 19 which determines that pre-set auction parameters have been met, such as length of auction coming to an end, or a reserve or buy it now being met. A bidder places a bid by selecting a predetermined bid which bid is then recorded in the bid database 9 and communicated to other users through the network 20 by way of refreshing their browsers 3 to show the new current asking price for the items/services being auctioned. Further, the computer program 7 would allow the generation of a printable receipt or confirmation to be sent to the bidder having the highest bid received from among the bidders at a conclusion of the on-line auction bidding process. Obviously, such a receipt of confirmation could be physically printed as confirmation of the reservation that can be presented by the highest bidder to the selected venue on the selected date.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the present invention is not limiting of the present invention. Thus, the operation and behavior of the aspects were described without reference to the specific software code, it being understood that a person of ordinary skill in the art would be able to design software and control hardware to implement the aspects based on the description herein.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A system for conducting an auction reservation process over a network, the system comprising:
providing a computing device associated with the network;
interconnecting, via the computing device, a plurality of venues through the network, each of the venues having means for displaying information regarding the plurality of venues to a plurality of prospective customers;
providing means for receiving reservation information for each of a selected date and a selected venue within the network from the prospective customers;
providing means for the prospective customers to select a specified reservation location within the selected venue in the network;
receiving auction bid information from the prospective customers to secure the specified reservation location within the selected venue in the network;
assessing the auction bid information received from any of the prospective customers to establish a highest bid for the specified reservation location within the selected venue in the network;
awarding the specified reservation location to the highest bid received from among the prospective customers; and
displaying the highest bid to all bidders for that specified reservation location within the selected venue from among the prospective establishment customers.

2. The system of claim 1, wherein the network is the Internet.

3. The system of claim 1, wherein the network is a wired network, a wireless network, a cellular telephone network, a telecommunications network or a mobile network.

4. The system of claim 1, wherein the network is a local area network (LAN), a wide area network (WAN), a telephone network, such as the Public Switched Telephone Network (PSTN), an intranet, the Internet, or a combination of interconnected and linked networks.

5. The system of claim 3, wherein the network can be interconnected and linked to other interconnected and linked networks.

6. The system of claim 1, wherein each of the plurality of venues subscribe to become members of the network.

7. The system of claim 1, wherein the step of receiving auction bid information from the prospective establishment customers further comprises a pre set acceptable price which, if the price is met from any of the prospective establishment customers, concludes the auction reservation process.

8. The system of claim 1, wherein the step of providing means for receiving reservation information from the prospective establishment customers further comprises a minimum reserve price being set, which, if the reserve price is not met from the prospective establishment customers, allows the auction reservation process to continue.

9. The system of claim 1, wherein, after the step of awarding the specified reservation location to the highest bid received, communication is forwarded to the bidders for that specified reservation location within the selected venue informing the bidders of an identity of the highest bid.

10. The system of claim 1, further comprising the step of allowing the plurality of venues to specify all reservation locations available in the network as menu items to be used as auction bid information in the auction reservation process.

11. The system of claim 1, wherein the step of receiving the auction bid information from the prospective customers further comprises the prospective customers using items sold at the selected venue in the network as a form of auction currency.

12. An auction reservation system for use over a network, the system comprising:
providing a computing device associated with the network;
interconnecting, via the computing device, a plurality of venues through the network, each of the venues having means for displaying information regarding the plurality of venues to a plurality of prospective customers;
providing means for receiving reservation information for each of a selected date and a selected venue within the network from the prospective customers;
providing means for the prospective customers to select a specified reservation location within the selected venue in the network;
receiving auction bid information from the prospective customers to secure the specified reservation location within the selected venue in the network;
assessing the auction bid information received from any of the prospective customers to establish a highest bid for the specified reservation location within the selected venue in the network;
awarding the specified reservation location to the highest bid received from among the prospective customers;
communicating to the bidders for that specified reservation location within the selected venue informing the bidders of an identity of the highest bid; and
displaying the highest bid to all bidders for that specified reservation location within the selected venue from among the prospective customers.

13. The system of claim 12, wherein the network is the Internet.

14. The system of claim 12, wherein the network is a wired network, a wireless network, a cellular telephone network, a telecommunications network or a mobile network.

15. The system of claim 12, wherein the network is a local area network (LAN), a wide area network (WAN), a telephone network, such as the Public Switched Telephone Network (PSTN), an intranet, the Internet, or a combination of interconnected and linked networks.

16. The system of claim 12, wherein the network can be interconnected and linked to other interconnected and linked networks.

17. The system of claim 12, wherein each of the plurality of venues subscribe to become members of the network.

18. The system of claim 12, wherein the step of receiving auction bid information from the prospective establishment customers further comprises a pre set acceptable price which, if the price is met from any of the prospective establishment customers, concludes the auction reservation process.

19. The system of claim 12, wherein the step of providing means for receiving reservation information from the prospective establishment customers further comprises a minimum reserve price being set, which, if the reserve price is not met from the prospective establishment customers, allows the auction reservation process to continue.

20. An auction reservation system for facilitating an on-line auction bidding process over a communications network, the system comprising:
at least one computing device associated with the communications network;
interconnecting, via the computing device, a plurality of venues through the network, each of the venues having means for displaying information regarding the plurality of venues to a plurality of prospective customers;
a central site for coupling to the communications network accessible by the plurality of prospective customers;
a server coupled to said central site and comprising a reservation availability database for storing reservation parameters relating to the plurality of venues in the network, a bidder database for storing information related to each bidders from among the plurality of prospective customers, and a processor programmed to:
(i) provide the prospective customers with auction bid information comprising items sold at the plurality of venues in the network as a form of auction currency through which a bid can be placed by any of the plurality of prospective customers;
(ii) receive reservation information for each of a selected date and a selected venue within the network from the bidders;
(iii) receive from the bidders a selection for a specified reservation location within a selected venue in the network;
(iv) receiving the bid from the bidders to secure the specified reservation location within the selected venue in the network;
(v) assess the bid received from the bidders to establish a highest bid for the specified reservation location within the selected venue in the network;
(vi) awarding the specified reservation location to a highest bid received from among the bidders; and
(vii) utilizing the sever to display on the central site and the network the highest bid for that specified reservation location within the selected venue from among the bidders; and
(viii) generating a printable receipt for the bidder having the highest bid received from among the bidders at a conclusion of the on-line auction bidding process.
